(19) United States
(12) Patent Application Publication
(10) Pub. No.: US 2026/0091823 A1
(43) Pub. Date: Apr. 2, 2026

(54) VEHICLE

(71) Applicant: TOYOTA JIDOSHA KABUSHIKI KAISHA, Toyota-shi (JP)

(72) Inventor: Takeo KAKISHIMA, Seto-shi (JP)

(73) Assignee: TOYOTA JIDOSHA KABUSHIKI KAISHA, Toyota-shi (JP)

(21) Appl. No.: 19/230,529

(22) Filed: Jun. 6, 2025

(30) Foreign Application Priority Data
Oct. 2, 2024 (JP) 2024-173205

(51) Int. Cl. B62D 21/15; B60K 1/04; B62D 21/03

(52) U.S. Cl. CPC B62D 21/157; B62D 21/03; B60K 1/04; B60K 2001/0438

(57) ABSTRACT

An EA member is disposed below a side frame to extend along the side frame. The EA member has a length in a vehicle lateral direction that is longer than a length of the side frame in the vehicle lateral direction, and includes an outer side portion positioned on an outer side in the vehicle lateral direction from the side frame and an inner side portion positioned on an inner side in the vehicle lateral direction from the side frame. A side protector is disposed in a step of the inner side portion, and a protruding wall of the side protector overlaps the side frame in the vehicle lateral direction. A second cross member is disposed between right and left EA members. At the time of side collision, the side frame abuts against the protruding wall, and thus the side frame is prevented from being greatly deformed.

### CROSS-REFERENCE TO RELATED APPLICATION

This application claims priority to Japanese Patent Application No. 2024-173205 filed on Oct. 2, 2024. The disclosure of the above-identified application, including the specification, drawings, and claims, is incorporated by reference herein in its entirety.

### BACKGROUND

### 1. Technical Field

The present disclosure relates to a vehicle.

### 2. Description of Related Art

Japanese Unexamined Patent Application Publication No. 2021-17181 (JP 2021-17181 A) discloses a support device for a vehicle battery that suspends a battery pack to a ladder frame of a vehicle. In JP 2021-17181 A, the battery pack is disposed between right and left side frames configuring the ladder frame.

### SUMMARY

At the time of side collision of the vehicle, the side frame may be deformed to a vehicle inner side. When the battery pack is disposed between the right and left side frames as in JP 2021-17181 A, at the time of great deformation of the side frame to the inner side, a large load may be applied to the battery pack.

The present disclosure has an object to prevent a side frame from being greatly deformed at the time of side collision of a vehicle.

A vehicle of the present disclosure is a vehicle including a pair of side frames extending in a vehicle front-rear direction. The vehicle includes: a pair of first members disposed below the side frames, the first members each extending along a corresponding one of the side frames and each having a length in a vehicle lateral direction that is longer than a length of the corresponding one of the side frames in the vehicle lateral direction; and a cross member disposed between the first members, the cross member extending in the vehicle lateral direction. The first members each include an outer side portion positioned on an outer side in the vehicle lateral direction from the corresponding one of the side frames, and an inner side portion positioned on an inner side in the vehicle lateral direction from the corresponding one of the side frames. The inner side portion includes a lap portion that overlaps the corresponding one of the side frames in the vehicle lateral direction.

With this configuration, the vehicle includes the side frames extending in the vehicle front-rear direction. The first members are disposed below the side frames. The first members each have a length in the vehicle lateral direction that is longer than the length of the side frame in the vehicle lateral direction, and each extend along the side frame. The vehicle includes the cross member disposed between the first members to extend in the vehicle lateral direction. The first member includes the outer side portion positioned on the outer side in the vehicle lateral direction from the side frame, and the inner side portion positioned on the inner side in the vehicle lateral direction from the side frame. The inner side portion of the first member includes the lap portion that overlaps the side frame in the vehicle lateral direction.

For example, when a side surface of the vehicle collides with a pole or the like, the outer side portion of the first member extending along the side frame abuts against the pole. The abutment of the pole causes the outer side portion of the first member to be deformed to the vehicle inner side, but the cross member extending in the vehicle lateral direction prevents the lap portion from entering the vehicle inner side. With the deformation of the outer side portion of the first member, the pole abuts against the side frame. When the side frame is deformed to the vehicle inner side due to the abutment of the pole, the side frame abuts against the lap portion of the first member. The cross member prevents the lap portion from entering the vehicle inner side, and hence further deformation of the side frame abutting against the lap portion is prevented. Thus, at the time of side collision of the vehicle, the side frame can be prevented from being greatly deformed.

At least the outer side portion of each of the first members may be configured from a shock absorption member that is to be deformed to absorb energy at the time of collision.

With this configuration, when the outer side portion of the first member is deformed to the vehicle inner side due to the abutment of the pole, the shock absorption member can absorb the collision energy. In this manner, it is possible to reduce an amount of deformation to the vehicle inner side of the side frame due to the abutment of the pole.

The lap portion may be configured from a member separate from each of the first members.

With this configuration, the lap portion is configured from a member separate from the first member, and hence it becomes easier to enhance the rigidity of the lap portion, and deformation of the side frame can be more suitably prevented.

The vehicle may further include a battery pack. The battery pack may be disposed between the side frames.

With this configuration, in the vehicle having mounted thereon the battery pack between the side frames, at the time of side collision of the vehicle, great deformation of the side frame can be prevented, and a collision load applied to the battery pack can be reduced.

The battery pack may include an accommodating case that accommodates a battery. The accommodating case may include an upper case and a lower case, and flange portions provided at peripheral edge portions of the upper case and the lower case may be joined to provide an accommodating space for the battery. The lap portion may be positioned between the flange portions and the corresponding one of the side frames in the vehicle lateral direction.

With this configuration, the lap portion is disposed between the side frame and the flange portions of the accommodating case in the vehicle lateral direction. At the time of side collision of the vehicle, the side frame abuts against the lap portion, and thus further deformation to the vehicle inner side is restrained. In this manner, the side frame can be prevented from abutting against the flange portions, and the flange portions can be prevented from being deformed. Further, even when the side frame abuts against the flange portions, the load applied to the flange portions can be reduced.

With the present disclosure, it is possible to prevent the side frame from being greatly deformed at the time of side collision of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration view of a body structure of a vehicle according to the present embodiment;

FIG. 2A is an explanatory view of a battery pack assembly to be attached to a chassis frame;

FIG. 2B is an explanatory view of the battery pack assembly to be attached to the chassis frame;

FIG. 3A is an explanatory view of a structure of mounting the battery pack assembly to the chassis frame;

FIG. 3B is an explanatory view of the structure of mounting the battery pack assembly to the chassis frame;

FIG. 4 is a view illustrating an IV-IV section of FIG. 3B;

FIG. 5A is an explanatory view of deformation of a side frame when a vehicle laterally collides with a pole;

FIG. 5B is an explanatory view of deformation of the side frame when the vehicle laterally collides with the pole;

FIG. 5C is an explanatory view of deformation of the side frame when the vehicle laterally collides with the pole; and

FIG. 6 is an explanatory view of an EA member in a modification example.

### DETAILED DESCRIPTION OF EMBODIMENTS

Hereinafter, an embodiment of the present disclosure is described in detail with reference to the drawings. It is to be noted that the same or corresponding parts in the drawings are denoted by the same reference symbols, and description thereof is not repeated. The dimensional relationships (the length, the width, the thickness, and the like) in the drawings do not reflect the actual dimensional relationships.

Further, the arrows Fr, Rr, Up, Lw, L, R in the drawings to be used in the following description indicate directions using the vehicle as a reference. The arrow Fr indicates “forward”, the arrow Rr indicates “rearward”, the arrow Up indicates “upward”, the arrow Lw indicates “downward”, the arrow L indicates “leftward”, and the arrow R indicates “rightward”.

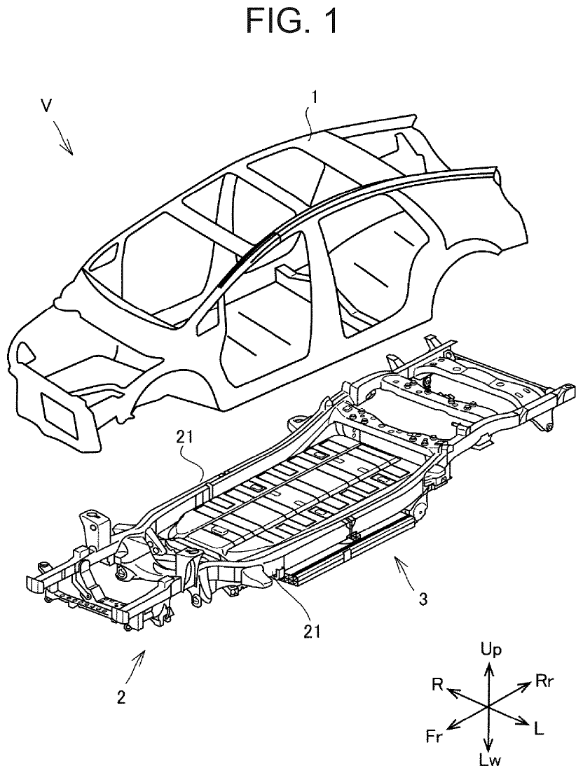

FIG. 1 is a schematic configuration view of a body structure of a vehicle V according to the present embodiment. The vehicle V of the present embodiment is an electrified vehicle such as a battery electric vehicle or a hybrid electric vehicle that can be driven by a motor. The body structure of the vehicle V is what is called a frame structure, and the body 1 is mounted on a chassis frame 2. In the present embodiment, the chassis frame 2 is what is called a perimeter frame or a ladder frame, and includes a pair of right and left side frames 21. On the chassis frame 2, a battery pack assembly 3, a suspension (not shown), a driving motor (not shown), and the like are attached.

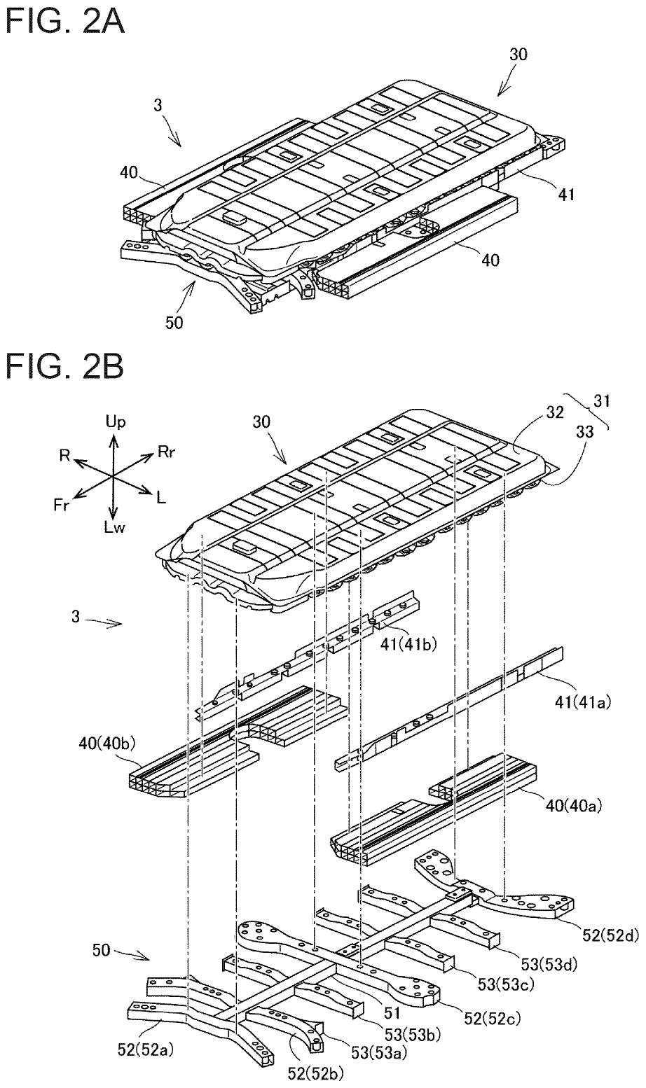

FIG. 2A and FIG. 2B are explanatory views of the battery pack assembly 3 to be attached to the chassis frame 2. FIG. 2A illustrates the battery pack assembly 3, and FIG. 2B is a schematic exploded view of the battery pack assembly 3. The battery pack assembly 3 includes a battery pack 30, a pair of shock absorption (energy absorption (EA)) members 40 (40a, 40b), a pair of side protectors 41 (41a, 41b), and a pack lower member 50. The battery pack 30 includes an accommodating case 31 that accommodates a battery module, and the accommodating case 31 is configured of an upper case 32 and a lower case 33. The EA members 40 each extend in the vehicle front-rear direction. The EA members 40 include a left EA member 40a disposed on the left side of the battery pack 30, and a right EA member 40b disposed on the right side of the battery pack 30. The side protectors 41 each extend in the vehicle front-rear direction. The side protectors 41 are positioned between the battery pack 30 and the EA members 40, and include a left side protector 41a disposed on the left side of the battery pack 30 and a right side protector 41b disposed on the right side of the battery pack 30.

The pack lower member 50 includes a front-rear direction member 51 extending in the vehicle front-rear direction, four first cross members 52 (52a to 52d) extending in the vehicle lateral direction (vehicle right-left direction), and four second cross members 53 (53a to 53d) extending in the vehicle lateral direction. The first cross members 52 (52a to 52d) have lengths in the vehicle lateral direction that are longer than the second cross members 53 (53a to 53d). It is to be noted that the number of first cross members 52 and the number of second cross members 53 may be any numbers.

As indicated by the long dashed double-short dashed lines of FIG. 2B, the EA members 40 and the side protectors 41 are fixed to the accommodating case 31 (the lower case 33) with a fastening member (bolt and nut) which is not shown. At this time, the left side protector 41a is fastened to the accommodating case 31 together with the left EA member 40a, and the right side protector 41b is fastened to the accommodating case 31 together with the right EA member 40b. It is to be noted that, in FIG. 2B, in order to avoid complexity of the drawings, fastening portions (jointly fastening portions) of the EA members 40 and the side protectors 41 to the accommodating case 31 are illustrated as four portions, but the number of fastening portions may exceed 20, for example. Further, as indicated by the dash-dotted lines of FIG. 2B, the pack lower member 50 is fixed to the accommodating case 31 (the lower case 33) with a fastening member which is not shown. In FIG. 2B, in order to avoid complexity of the drawings, fastening portions (jointly fastening portions) of the pack lower member 50 to the accommodating case 31 are illustrated as six portions, but the number of fastening portions may exceed 20, for example.

As described above, with the EA members 40, the side protectors 41, and the pack lower member 50 being fixed (assembled) to the accommodating case 31, the battery pack assembly 3 illustrated in FIG. 2A is configured.

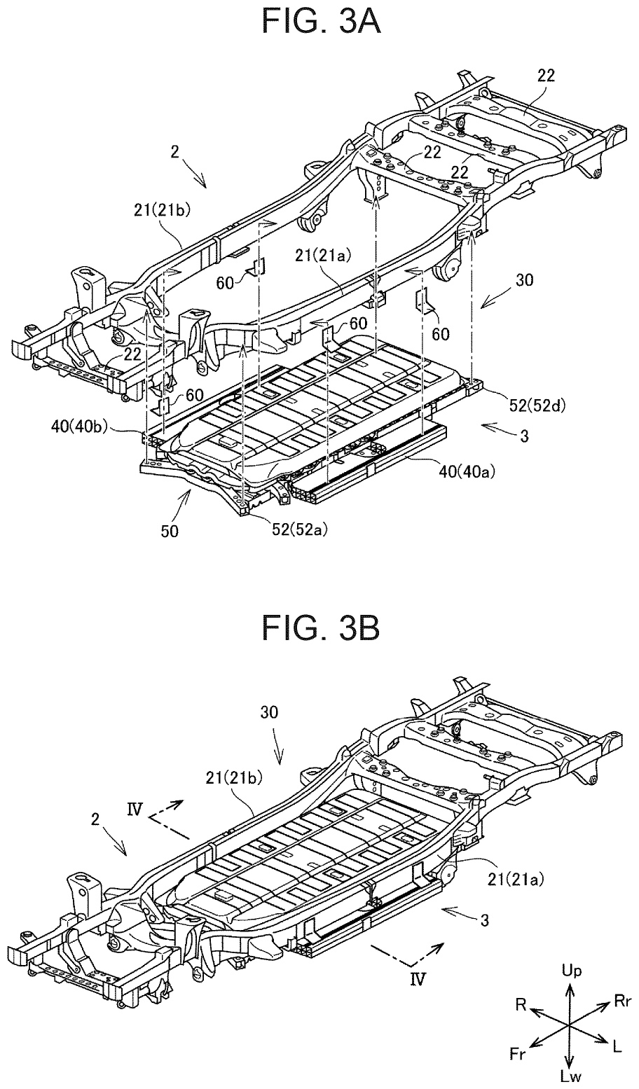

FIG. 3A and FIG. 3B are explanatory views of a structure of mounting the battery pack assembly 3 to the chassis frame 2. FIG. 3A is an assembly view of the battery pack assembly 3 to the chassis frame 2, and FIG. 3B illustrates the chassis frame 2 after the battery pack assembly 3 is mounted thereon. As illustrated in FIG. 3A, the chassis frame 2 includes the side frames 21 extending in the vehicle front-rear direction. The side frames 21 include a left side frame 21a and a right side frame 21b. The side frames 21 (21a, 21b) are coupled by a plurality of cross frames (cross members) 22. In the present embodiment, the cross frames 22 are disposed in a front portion and a rear portion of the vehicle, and no cross frame is disposed at a position at which the battery pack assembly 3 is to be mounted.

As indicated by the dash-dotted lines of FIG. 3A, the battery pack assembly 3 is fastened to the side frames 21 (21a, 21b) by a fastening member which is not shown. For example, as indicated by the dash-dotted lines of FIG. 3A, the first cross members 52 (52a to 52d) of the pack lower member 50 are fastened to the side frames 21 (21a, 21b). Further, as indicated by the long dashed double-short dashed lines of FIG. 3A, the EA members 40 (40a, 40b) are fastened to the side frames 21 (21a, 21b). At this time, the EA members 40 (40a, 40b) may be fastened to the side frames 21 (21a, 21b) via attachment brackets 60. It is to be noted that FIG. 3A illustrates, in order to avoid complexity of the drawings, typical fastening portions (the dash-dotted lines and the long dashed double-short dashed lines). For example, all of the first cross members 52 (52a to 52d) are fastened to the side frames 21 (21a, 21b), and, also in the EA members 40 (40a, 40b), portions that are not shown are fastened to the side frames 21 (21a, 21b).

When the battery pack assembly 3 is assembled to the chassis frame 2, as illustrated in FIG. 3B, the battery pack 30 is disposed between the left side frame 21a and the right side frame 21b.

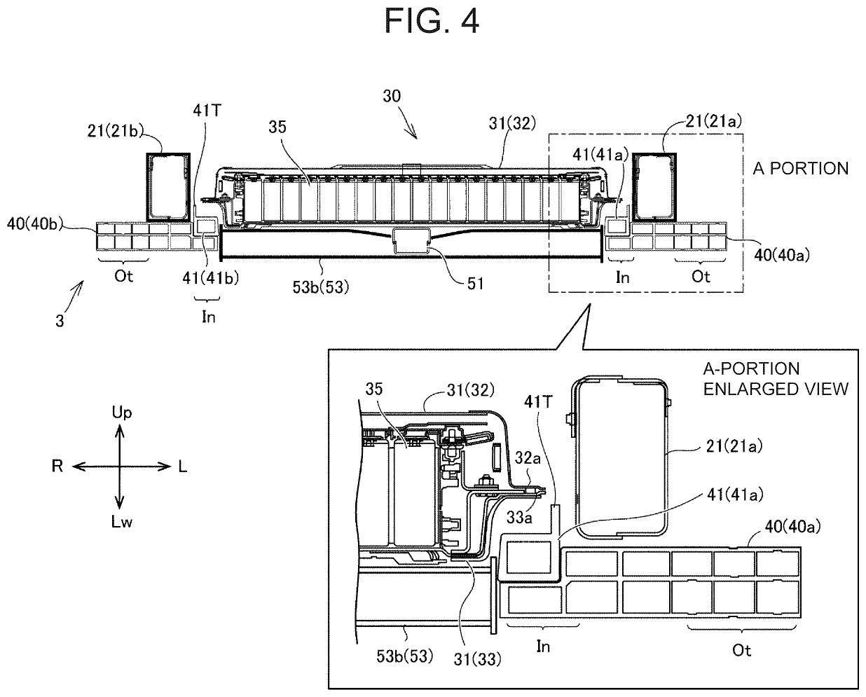

FIG. 4 is a view illustrating an IV-IV section of FIG. 3B. A battery cell (single battery) 35 is accommodated in the accommodating case 31 of the battery pack 30. The battery cell 35 may be, for example, a lithium-ion battery or a nickel-hydrogen battery. In the accommodating case 31, a plurality of battery cells 35 is accommodated in a mode of an assembled battery (a battery module) in which the battery cells 35 are connected in series or in parallel. As illustrated in an A-portion enlarged view, the accommodating case 31 is configured of the upper case 32 and the lower case 33. A flange portion 32a is formed in a peripheral edge portion of the upper case 32. A flange portion 33a is formed in a peripheral edge portion of the lower case 33. The accommodating case 31 is formed by joining the flange portion 32a and the flange portion 33a with a seal member being sandwiched between the flange portion 32a and the flange portion 33a.

The left EA member 40a is disposed below the left side frame 21a, and extends in the vehicle front-rear direction along the left side frame 21a (see FIG. 3B). The length (the width) of the left EA member 40a in the vehicle lateral direction is longer than the length (the width) of the left side frame 21a in the vehicle lateral direction. The left EA member 40a includes an outer side portion Ot positioned on the outer side in the vehicle lateral direction (the vehicle left direction) from the left side frame 21a, and an inner side portion In positioned on the inner side in the vehicle lateral direction (the vehicle middle direction) from the left side frame 21a.

The right EA member 40b is disposed below the right side frame 21b, and extends in the vehicle front-rear direction along the right side frame 21b. The length (the width) of the right EA member 40b in the vehicle lateral direction is longer than the length (the width) of the right side frame 21b in the vehicle lateral direction. The right EA member 40b includes an outer side portion Ot positioned on the outer side in the vehicle lateral direction (the vehicle right direction) from the right side frame 21b, and an inner side portion In positioned on the inner side in the vehicle lateral direction (the vehicle middle direction) from the right side frame 21b.

The EA members 40 (40a, 40b) are each formed from, for example, an aluminum alloy, and each have a ladder-shaped (ladder-like) sectional structure to be deformed to absorb collision energy. Steps that receive the side protectors 41 (41a, 41b) are formed above the inner side portions In of the EA members 40 (40a, 40b). The steps extend in the vehicle front-rear direction. The side protectors 41 (41a, 41b) are disposed in the vehicle front-rear direction along the steps formed in the inner side portions In. The side protectors 41 (41a, 41b) each have a rectangular pipe shape with a closed section, and each include a protruding wall 41T projecting upward of the vehicle. The protruding walls 41T protrude up to positions overlapping the side frames 21 (21a, 21b) in the vehicle lateral direction (vehicle right-left direction). The protruding walls 41T are each positioned between the flange portions 32a, 33a of the accommodating case 31 and the side frames 21 (21a, 21b) in the vehicle lateral direction, and each extend in the vehicle front-rear direction.

The second cross member 53b is disposed between the left EA member 40a and the left side protector 41a and the right EA member 40b and the right side protector 41b. The second cross member 53b transmits a side collision load (side collision input) applied to the EA member 40 (40a, 40b) and the side protector 41 (41a, 41b) by the side collision of the vehicle V to the counter-side-collision side. In this manner, the EA member 40 (40a, 40b) and the side protector 41 (41a, 41b) on the side-collision side are prevented from being deformed to the inner side in the vehicle lateral direction. Other second cross members 53 (53a, 53c, 53d) are also similarly disposed.

It is to be noted that the EA member 40 (40a, 40b), the outer side portion Ot, and the inner side portion In of the present embodiment respectively correspond to examples of a “first member”, an “outer side portion”, and an “inner side portion” of the present disclosure. The protruding wall 41T of the side protector 41 (41a, 41b) corresponds to an example of a “lap portion” of the present disclosure. The second cross member 53 corresponds to an example of a “cross member” of the present disclosure.

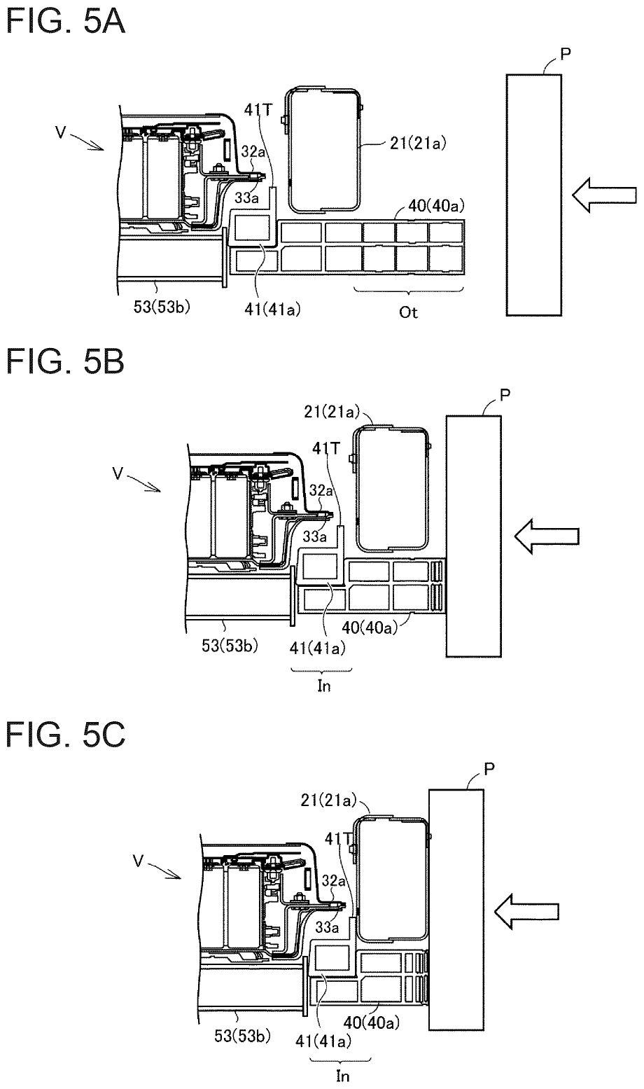

FIG. 5A, FIG. 5B, and FIG. 5C are explanatory views of deformation of the side frame 21 when the vehicle V laterally collides with a pole P. FIG. 5A to FIG. 5C illustrate an example of side collision on the left side of the vehicle V. FIG. 5A is a view illustrating immediately before collision of the vehicle V with the pole P by side collision. When the vehicle V collides with the pole P, as illustrated in FIG. 5B, the outer side portion Ot of the left EA member 40a is deformed to absorb the collision energy. At this time, the second cross member 53 transmits the side collision load (side collision input) applied to the left EA member 40a and the left side protector 41a to the counter-side-collision side (the right side frame 21b side). In this manner, the deformation (entry) of the left EA member 40a and the left side protector 41a to the inner side in the vehicle lateral direction is prevented, and the collision load is prevented from being input to the battery pack 30 (the accommodating case 31) from the left EA member 40a and the left side protector 41a.

As illustrated in FIG. 5C, when the pole P enters the vehicle V until the pole P abuts against the left side frame 21a, the left side frame 21a is displaced (deformed) to the inner side in the vehicle lateral direction to abut against the protruding wall 41T of the left side protector 41a. With the second cross member 53, the deformation (entry) of the left side protector 41a to the inner side in the vehicle lateral direction is prevented, and hence further deformation (entry) of the left side frame 21a abutting against the protruding wall 41T is prevented. Thus, at the time of side collision of the vehicle V, the left side frame 21a can be prevented from being greatly deformed. Further, it is possible to prevent a collision load from being applied from the left side frame 21a to the battery pack 30. It is to be noted that the same holds true also in the case of side collision on the right side of the vehicle V.

In the present embodiment, the protruding wall 41T of the side protector 41 (41a, 41b) is disposed between the flange portions 32a, 33a of the accommodating case 31 and the side frame 21 (21a, 21b) in the vehicle lateral direction. At the time of side collision of the vehicle V, the side frame 21 (21a, 21b) abuts against the protruding wall 41T, and thus further deformation to the vehicle inner side is prevented. In this manner, abutment of the side frame 21 (21a, 21b) against the flange portions 32a, 33a can be restrained, and the deformation of the flange portions 32a, 33a can be prevented. Thus, the seal performance (airtightness) of the accommodating case 31 can be ensured.

### Modification Example

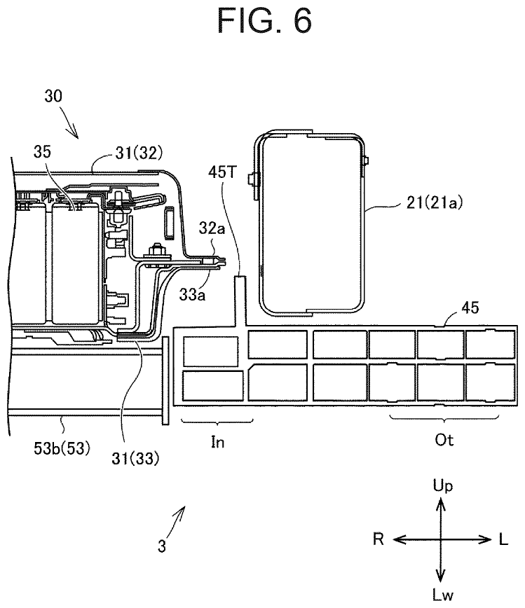

FIG. 6 is an explanatory view of an EA member 45 in a modification example. FIG. 6 corresponds to the A-portion enlarged view of FIG. 4 in the above-mentioned embodiment. In the above-mentioned embodiment, the step for receiving the side protector 41 is formed above the inner side portion In of the EA member 40, and the side protector 41 including the protruding wall 41T is disposed in the vehicle front-rear direction along the step. The EA member 45 of the modification example is a member in which the EA member 40 and the side protector 41 are integrated.

With reference to FIG. 6, the EA member 45 is disposed below the side frame 21 to extend in the vehicle front-rear direction along the side frame 21. The length (the width) of the EA member 45 in the vehicle lateral direction is longer than the length (the width) of the side frame 21 in the vehicle lateral direction. The EA member 45 includes an outer side portion Ot positioned on the outer side in the vehicle lateral direction from the side frame 21, and an inner side portion In positioned on the inner side in the vehicle lateral direction (the vehicle middle direction) from the side frame 21. In the inner side portion In of the EA member 45, a protruding wall 45T extending to the vehicle upper side is integrally formed. The protruding wall 45T protrudes up to a position overlapping the side frame 21 in the vehicle lateral direction (the vehicle right-left direction). The protruding wall 45T is positioned between the flange portions 32a, 33a of the accommodating case 31 and the side frame 21 in the vehicle lateral direction.

Also in this modification example, with the second cross member 53, deformation (entry) of the EA member 45 to the inner side in the vehicle lateral direction is prevented, and hence, at the time of side collision, further deformation (entry) of the side frame 21 abutting against the protruding wall 45T is prevented. Thus, it is possible to prevent the side frame 21 from being greatly deformed at the time of side collision of the vehicle V.

The embodiment disclosed herein is illustrative and not restrictive in all respects. The scope of the present disclosure is defined by not the description of the above embodiment but the appended claims. The scope of the present disclosure is intended to encompass all modifications within the scope of the appended claims and equivalents thereof.

What is claimed is:

1. A vehicle including a pair of side frames extending in a vehicle front-rear direction, the vehicle comprising:
a pair of first members disposed below the side frames, the first members each extending along a corresponding one of the side frames and each having a length in a vehicle lateral direction that is longer than a length of the corresponding one of the side frames in the vehicle lateral direction; and
a cross member disposed between the first members, the cross member extending in the vehicle lateral direction, wherein:
the first members each include an outer side portion positioned on an outer side in the vehicle lateral direction from the corresponding one of the side frames, and an inner side portion positioned on an inner side in the vehicle lateral direction from the corresponding one of the side frames; and
the inner side portion includes a lap portion that overlaps the corresponding one of the side frames in the vehicle lateral direction.

2. The vehicle according to claim 1, wherein at least the outer side portion of each of the first members is configured from a shock absorption member that is to be deformed to absorb energy at the time of collision.

3. The vehicle according to claim 2, wherein the lap portion is configured from a member separate from each of the first members.

4. The vehicle according to claim 1, further comprising a battery pack, wherein the battery pack is disposed between the side frames.

5. The vehicle according to claim 4, wherein:
the battery pack includes an accommodating case that accommodates a battery;
the accommodating case includes an upper case and a lower case, and flange portions provided at peripheral edge portions of the upper case and the lower case are joined to provide an accommodating space for the battery; and
the lap portion is positioned between the flange portions and the corresponding one of the side frames in the vehicle lateral direction.
